(19) United States
(12) Patent Application Publication
(10) Pub. No.: US 2003/0106952 A1
(43) Pub. Date: Jun. 12, 2003

(54) Candy cruncher

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 South Cleveland Street, Arlington, VA, 22204-2038, US

(21) Appl. No.: 10/003,183

(22) Filed: Dec. 6, 2001

(51) Int. Cl. B02C 1/10

(52) U.S. Cl. 241/264

(57) ABSTRACT

The candy cruncher is a candy dispenser that allows a person to crush hard candy pieces into a crushed or powdered form. The device comprises a main housing with an aperture located at the upper end, character appendages, flanges, crushed candy, anchor pin, a slotted dispensing disk and a base with a dispensing aperture. A secondary housing comprises a pivot handle, a stationary handle, a pivot pin, an anchor pin, a leverage pedal, a slot at an upper portion of the secondary housing, a candy loading aperture, a door with hinge, stationary grinding teeth angled upward, movable grinding teeth angled downward, a spring, a push rod and candy to be crunched.

### BACKGROUND OF THE INVENTION

This invention relates to a candy dispenser and more particularly to a candy cruncher which crunches larger pieces of candy into a powder form or smaller pieces of candy particles.

Prior Art

Heretofore applicants have patented different candy dispensing devices which dispense the same sized pieces of candy from a reservoir into a person's hand for consumption. Such pieces of candy are dispensed with the same size as the size of the pieces of candy contained within the reservoir.

### SUMMARY OF THE INVENTION

An advantage of the invention is to break larger pieces of candy into smaller sized particles or a powder.

Another advantage would be to break larger sized pills of a medicine into smaller particle sizes or to a powder.

Another object of the invention is to break larger pieces of candy or any other larger breakage piece of a product into smaller size particles or a powder for consumption.

Another object is to break larger pieces of different flavored candy into smaller size particles or a powder of a mixture of the different flavor candies. Thus, the small particles or powder would be a composite flavor of the different flavors.

Other objects and advantages of the invention will become obvious to those skilled in the art upon a review of the drawings, specification and claims.

### BRIEF DESCRIPTION OF THE DRAWINGS

FIG. 1 illustrates a device without any candy pieces therein ready to start crunching the pieces of candy;

FIG. 2 illustrates a device loaded with pieces of candy with the crunching teeth in a crunching position shown with powdered candy dropping into a reservoir from which the powder is dispensed; and

FIG. 4 illustrates a dispensing disk for dispensing the candy particles or powder from the reservoir.

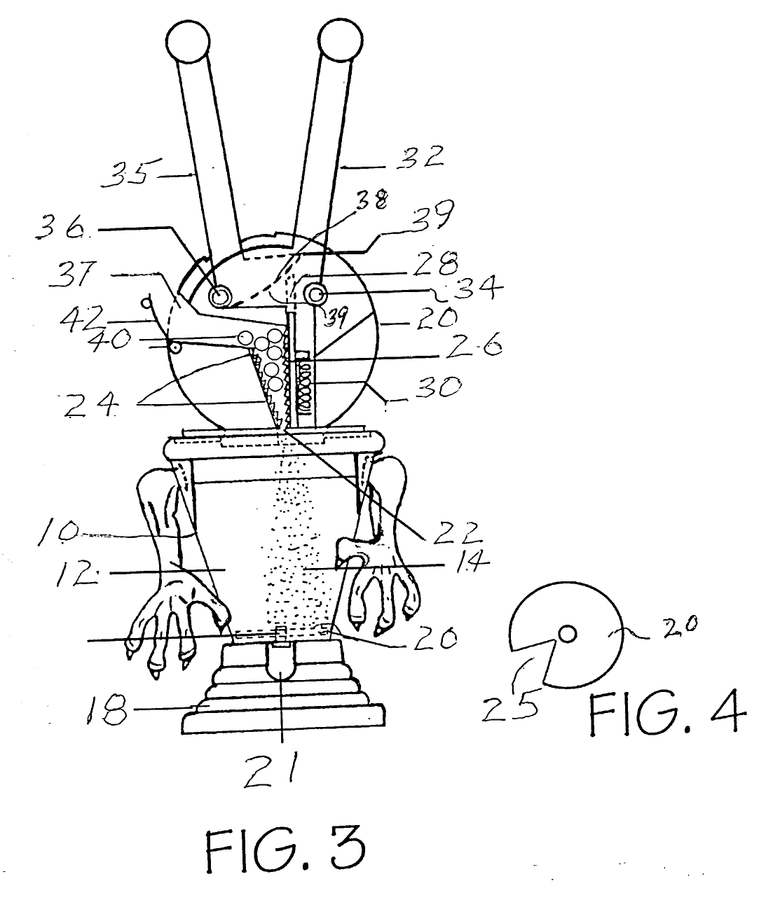

### DETAILED DESCRIPTION OF THE INVENTION

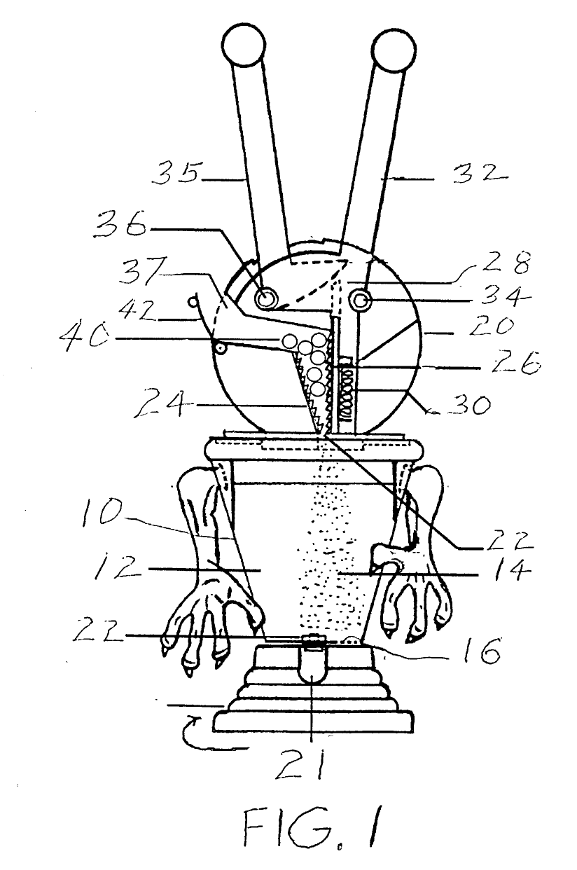

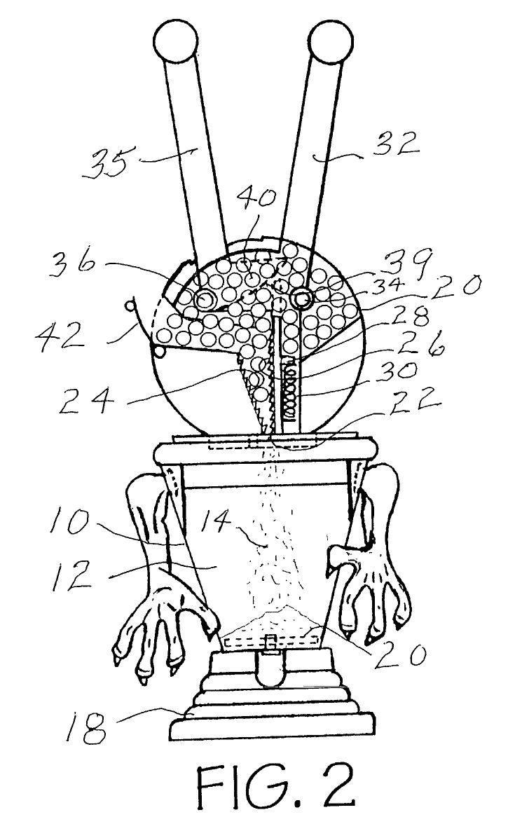

Now referring to the drawings, there is shown in FIGS. 1-3 a cruncher for crunching large pieces of a product such as candy or medical pills into small particles or a powder. The device includes a main housing 10 which also functions as a reservoir 12 for receiving the small particles or powder 14 and from which the small particles or powder are dispensed through a dispensing aperture 16 in the main housing base 18 by use of a dispensing disk 21. The dispensing disk is fixed in place by a central anchor pin 22 which secures the dispensing disk onto the housing base. The dispensing disk has an angular slot 25 or circular opening in alignment with the opening in the housing bottom through which the small particles or powder are dispensed to a person. The small particles are dispensed by rotation of the base of the housing which aligns an opening with the slotted dispensing disk.

A secondary housing 20 is secured to an upper end of the main housing coaxial with an aperture 22 in the upper end of the main housing. The secondary housing comprises stationary grinding teeth 24 which are positioned at an angle relative to movable grinding teeth 26. The fixed teeth are angled upwardly and the movable grinding teeth are angled downwardly relative to the fixed teeth. The movable grinding teeth are fixed onto a push rod 28 which is movable upwardly by a force of a spring 30 that forces the push rod upwardly. In order to move the push rod and grinding teeth thereon downwardly, a fixed stationary handle 32 is secured by an anchor 34 to an upper end of the housing and is held by one's hand while moving a pivotable handle 35 which is pivoted on a pivot pin 36. The movable handle is provided with a leverage foot 38 or pedal which has a circular lower cam surface 39 that contacts an upper end of the push rod on which the grinding teeth 26 are fixed. The product pieces 40 are loaded into the upper housing through a hinged door 42 which is closed during the grinding process.

In operation, the upper housing is loaded with a product 40 to be crunched. As shown, some of the pieces settle into the slot between the fixed teeth 24 and the movable teeth 26. In order to crunch the product, the fixed handle 32 is held by the hand and the person's fingers surround the pivotable handle 34 to force the pivotable handle toward the fixed handle. As the pivoted handle is forced toward the fixed handle 32, the cam surface 39 of the leverage foot contacts the upper end of the push rod to force the push rod downwardly against the spring force. As the push rod is pushed downwardly, the movable teeth fixed to the push rod are moved downwardly relative to the teeth fixed on the housing to crunch the product. When the pivotable handle is released, the spring forces the push rod and movable teeth upwardly. In order to repeat movement of the pivoted handle to force the push rod downwardly the pivoted handle is pulled toward the fixed handle. Repeating movement of the pivoted handle against the upper end of the push rod crunches the product and the crunched small particles or powder drop into the reservoir of the main housing. After sufficient small particles or powder have been crunched, the base is rotated in order to align the slot in the dispensing disk with the aperture or opening in the bottom of the housing which permits the candy powder to fall into the dispensing slot.

In order to add amusing features to the device, appendages can be anchored to the sides of the housing for movement relative to the housing. The appendages shown are funny looking arms. Along with the appendages, the housings could be decorated in an amusing design of different characters, animals, aliens, persons, etc.

The foregoing relates to preferred exemplary embodiments of the invention, it being understood that other variants and embodiments thereof are possible within the spirit and scope of the invention, the latter being defined by the appended claims.

We claim:

1. A product cruncher which comprises
a main housing,
a secondary housing,
means for crunching pieces of a product,
a reservoir in said main housing for collecting particles of the crunched product, and
an outlet for dispensing the particles of crunched product.

2. A product cruncher as set forth in claim 1, in which
said means for crunching said product is a non-movable tooth means, and
a movable tooth means which moves relative to said non-movable tooth means.

3. A product cruncher as set forth in claim 2, in which said main housing includes an inlet through which crunched particles fall into said reservoir.

4. A product cruncher as set forth in claim 2, in which
said movable teeth are secured onto a push rod, and
a spring means for applying an upward force on said push rod to force said push rod into a rest position relative to the non-movable teeth.

5. A product cruncher as set forth in claim 3 in which
said movable teeth are secured onto a push rod, and
a spring means for applying an upward force on said push rod to force said push rod into a rest position relative to the non-movable teeth.

6. A product cruncher as set forth in claim 3, which includes
a stationary handle (32) fixed to and extending upwardly from said upper housing (20), and
a movable handle spaced from said stationary handle and pivoted about a pivot pin (36) secured in said secondary housing,
said movable handle including a cam which contacts an upper end of the push rod for operation of the push rod.

7. A product cruncher as set forth in claim 4, which includes
a stationary handle (32) fixed to and extending upwardly from said upper housing (20), and
a movable handle spaced from said stationary handle and pivoted about a pivot pin (36) secured in said secondary housing,
said movable handle including a cam which contacts an upper end of the push rod for operation of the push rod.

8. A product cruncher as set forth in claim 5, which includes
a stationary handle (32) fixed to and extending upwardly from said upper housing (20), and
a movable handle spaced from said stationary handle and pivoted about a pivot pin (36) secured in said secondary housing,
said movable handle including a cam which contacts an upper end of the push rod for operation of the push rod.

9. A product cruncher as set forth in claim 1, in which said outlet includes a rotatable dispensing disk for dispensing crunched particles through said outlet of said main housing.

10. A product cruncher as set forth in claim 2, in which said outlet includes a rotatable dispensing disk for dispensing crunched particles through said outlet of said main housing.

11. A product cruncher as set forth in claim 3, in which said outlet includes a rotatable dispensing disk for dispensing crunched particles through said outlet of said main housing.

12. A product cruncher as set forth in claim 4, in which said outlet includes a rotatable dispensing disk for dispensing crunched particles through said outlet of said main housing.

13. A product cruncher as set forth in claim 5, in which said outlet includes a rotatable dispensing disk for dispensing crunched particles through said outlet of said main housing.

14. A product cruncher as set forth in claim 6, in which said outlet includes a rotatable dispensing disk for dispensing crunched particles through said outlet of said main housing.

15. A product cruncher as set forth in claim 7, in which said outlet includes a rotatable dispensing disk for dispensing crunched particles through said outlet of said main housing.

16. A product cruncher as set forth in claim 8, in which said outlet includes a rotatable dispensing disk for dispensing crunched particles through said outlet of said main housing.

17. A product cruncher as set forth in claim 9, in which said main housing includes appendages which relate to some character or animal.
